(19) United States
(12) Patent Application Publication
(10) Pub. No.: US 2022/0200082 A1
(43) Pub. Date: Jun. 23, 2022

(54) SPACE FILLERS FOR ELECTROCHEMICAL CELL PACKS

(71) Applicant: 3M INNOVATIVE PROPERTIES COMPANY, St. Paul, MN (US)

(72) Inventors: Bamidele O. Fayemi, Cottage Grove, MN (US); Petra M. Stegmaier, Duesseldorf (DE); Tyler S. Matthews, Apple Valley, MN (US)

(21) Appl. No.: 17/611,499

(22) PCT Filed: May 12, 2020
(86) PCT No.: PCT/IB2020/054480

§ 371 Date: Nov. 15, 2021

Related U.S. Application Data
(60) Provisional application No. 62/898,985, filed on Sep. 11, 2019.
(60) Provisional application No. 62/848,626, filed on May 16, 2019.

(51) Int. Cl. H01M 10/6568; H01M 50/471; H01M 10/6554

(52) U.S. Cl. CPC H01M 10/6568; H01M 10/6554; H01M 50/471

(57) ABSTRACT

An electrochemical cell pack includes a housing having an interior space; a plurality of electrochemical cells disposed within the interior space; a thermal management fluid disposed within the interior space such that the electrochemical cell is in thermal communication with the thermal management fluid; and one or more space fillers disposed with the interior volume and in direct contact with the thermal management fluid. The space fillers have a density that is less than the density of the thermal management fluid.

### FIELD

The present disclosure relates to space fillers for use in electrochemical cell packs.

### BACKGROUND

Thermal management systems for electrochemical cell packs are described in, for example, U.S. Pat. App. Pub. 2017/0279172, U.S. Pat. No. 8,852,772, U.S. Pat. App. Pub. 2017/0279172, DE Pat. App. 102015005529, and DE Pat. App. 102013213550.

### SUMMARY

In some embodiments, an electrochemical cell pack is provided. The electrochemical cell pack includes a housing having an interior space; a plurality of electrochemical cells disposed within the interior space; a thermal management fluid disposed within the interior space such that the electrochemical cell is in thermal communication with the thermal management fluid; and one or more space fillers disposed with the interior volume and in direct contact with the thermal management fluid. The space fillers have a density that is less than the density of the thermal management fluid.

In some embodiments, an electrochemical cell pack is provided. The electrochemical cell pack includes a housing having an interior space; a plurality of electrochemical cells disposed within the interior space; a thermal management fluid disposed within the interior space such that the electrochemical cell is in thermal communication with the thermal management fluid; and one or more space fillers disposed with the interior volume and in direct contact with the thermal management fluid. The volume occupied by the space fillers within the interior space, cumulatively, is at least 20% of the volume occupied by the thermal management fluid within the interior space.

The above summary of the present disclosure is not intended to describe each embodiment of the present disclosure. The details of one or more embodiments of the disclosure are also set forth in the description below. Other features, objects, and advantages of the disclosure will be apparent from the description and from the claims.

### BRIEF DESCRIPTION OF THE DRAWINGS

FIG. 1 is a schematic side view of an electrochemical cell pack according to some embodiments of the present disclosure.

FIG. 2 is a schematic side view of an electrochemical cell pack according to some embodiments of the present disclosure.

FIG. 3 is a schematic side view of an electrochemical cell pack according to some embodiments of the present disclosure.

FIG. 4 is a perspective view of a space filler according to some embodiments of the present disclosure.

FIG. 5 is a top view of the space fillers of FIG. 4 disposed adjacent a plurality of electrochemical cells.

FIG. 6 is a perspective view of a space filler according to some embodiments of the present disclosure.

FIG. 7 is a schematic perspective view of an electrochemical cell pack according to some embodiments of the present disclosure.

FIG. 8 is a top view of a test configuration of a pack of electrochemical cells for exemplary embodiments of the present disclosure.

FIG. 9 is a schematic of a test vessel containing no space fillers.

FIG. 10 is a schematic of a test vessel containing space fillers of the present disclosure.

FIGS. 11 and 12 show graphs of the average pack temperatures and voltages during cycling for Example 1 and the Comparative Example.

### DETAILED DESCRIPTION

Electrochemical cells (e.g., lithium-ion batteries) are in widespread use worldwide in a vast array of electronic and electric devices ranging from hybrid and electric vehicles to power tools, portable computers, and mobile devices.

Thermal management systems for packs of electrochemical cells (e.g., lithium-ion battery packs) are often required to maximize the cycle life of the cells and for safety. These types of thermal management systems function to control/maintain the temperature of the cells within the pack. High temperatures can increase the capacity fade rate and impedance of the cells while decreasing their lifespan.

While generally safe and reliable energy storage devices, electrochemical cells are subject to catastrophic failure known as thermal runaway under certain conditions. Thermal runaway is a series of internal exothermic reactions that are triggered by heat. The creation of excessive heat can be from electrical over-charge, thermal over-heat, or from an internal electrical short. Internal shorts are typically caused by manufacturing defects or impurities, dendritic lithium formation, or mechanical damage.

Effective thermal management of electrochemical cells, or packs of electrochemical cells, can assist in the prevention of catastrophic, thermal runaway events while also providing necessary ongoing thermal management for the efficient normal operation of the packs. Such thermal management can be achieved for example by dielectric fluids, using a system designed for single phase or two-phase immersion or direct contact thermal management. In either scenario, thermal management fluids are placed in thermal communication with the electrochemical cells to maintain, increase, or decrease the temperature of the electrochemical cells (i.e., heat may be transferred to or from the electrochemical cells via the fluid).

To sufficiently protect against the potential harmful effects of thermal runaway propagation, significant quantities of thermal management fluid are required to be contained within the electrochemical cell packs. However, most industries where fluid immersion thermal management may be employed are driven, at least in part, by weight reduction and cost down considerations. In this regard, in known immersion thermal management systems, the amount of fluid that may be necessary to adequately mitigate against thermal runaway events, may result in pack weights or pack costs that are unacceptably high. Consequently, systems, articles, and methods for minimizing the amount of thermal management fluid (and thus the weight and cost of the electrochemical cell pack) needed to properly manage the temperature of electrical cell packs and sufficiently protect against the potential harmful effects of thermal runaway propagation are desirable.

Generally, the present disclosure is directed to electrochemical cell packs that include low cost, light weight space fillers disposed therein such that an amount of thermal management fluid within the electrochemical cell packs may be reduced or minimized. Benefits and characteristics of the space fillers of the present disclosure may include:
Provides a space filling solution to reduce volume and weight of the working fluid in electrochemical cell pack thermal management systems.
Eliminates or minimizes interactions between the thermal management fluid and the space filler by providing a membrane material that are compatible with the thermal management fluid
Eliminates or minimizes permeation of thermal management fluid into the space filler, thereby increasing fluid volume displacement.
Provides compression properties to compensate for volume or pressure changes, generated by breathing of cells upon electrochemical cycling or pressure and temperature related volume changes of thermal management fluid.

As used herein, “catenated heteroatom” means an atom other than carbon (for example, oxygen, nitrogen, or sulfur) that is bonded to at least two carbon atoms in a carbon chain (linear or branched or within a ring) so as to form a carbon-heteroatom-carbon linkage.

As used herein, “fluoro-” (for example, in reference to a group or moiety, such as in the case of “fluoroalkylene” or “fluoroalkyl” or “fluorocarbon”) or “fluorinated” means (i) partially fluorinated such that there is at least one carbon-bonded hydrogen atom, or (ii) perfluorinated.

As used herein, “perfluoro-” (for example, in reference to a group or moiety, such as in the case of “perfluoroalkylene” or “perfluoroalkyl” or “perfluorocarbon”) or “perfluorinated” means completely fluorinated such that, except as may be otherwise indicated, there are no carbon-bonded hydrogen atoms replaceable with fluorine.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

In some embodiments, the present disclosure relates to an electrochemical cell pack that contains one or more space fillers. Generally, the electrochemical cell packs may include a housing defining an interior volume that contains a plurality of electrochemical cells. A thermal management fluid may be disposed within the interior volume of the housing such that the fluid is in thermal communication with one or more (up to all) of the electrochemical cells. Thermal communication may be achieved via direct contact immersion, or indirect thermal contact. In embodiments in which direct contact immersion is employed, the thermal management fluid may surround and directly contact any portion (up to totally surround and directly contact) one or more (up to all) of the electrochemical cells. In some embodiments, the electrochemical cells may be rechargeable batteries (e.g., rechargeable lithium-ion batteries). In some embodiments, the space fillers may be in direct contact with the thermal management fluid (e.g., the space fillers may be at least partially immersed (up to totally immersed) in the thermal management fluid)). In some embodiments, the space fillers may have a density that is less than the density of the thermal management fluid. In some embodiments, the space fillers may have a density that is equal to or more than the thermal management fluid. For purposes of the present application, it is to be appreciated that electrochemical cells (e.g., batteries) are not to be considered space fillers.

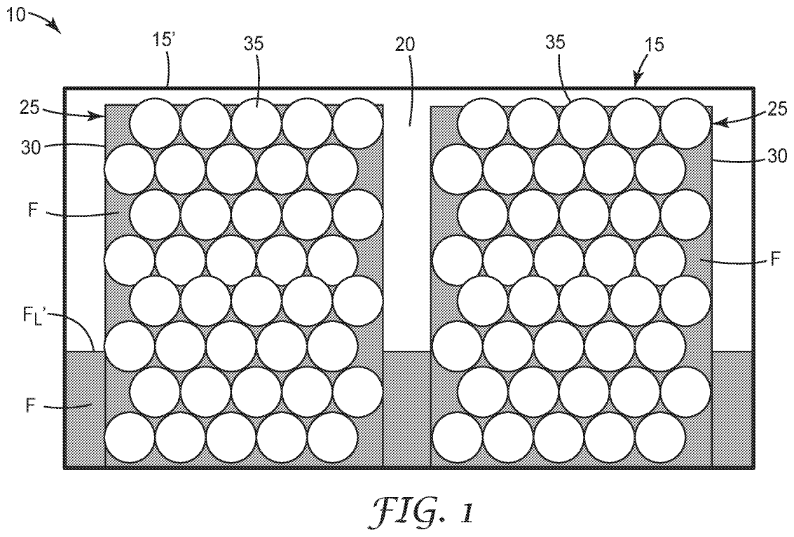

Referring now to FIG. 1, an electrochemical cell pack 10 (shown without space fillers for illustrative purposes) according to some embodiments of the present is depicted. The electrochemical cell pack 10 may include a housing 15 that defines an interior space 20. A plurality of modules 25 may be disposed within the interior space 20. The housing 10 may be formed in any conventional fashion and of any conventional materials that allow for the interior space to be fluidically sealed (except for, for example, one or more vents that may permit outgassing under certain conditions). While the electrochemical cell pack 10 is shown with only two modules, only one module 25 or any number of modules greater than two may be employed.

In some embodiments, although not shown, the modules 25 (and/or the electrochemical cells) may be electrically connected to each other using any electrical conductor, such as busbars, wires, cables, or the like. The battery modules may be electrically coupled in a series configuration, a parallel configuration, or some combination of parallel and series configurations, as desired for the particular application.

In some embodiments, each of the modules 25 may include a casing 30 that defines an interior volume of the modules 25 and contains a plurality of electrochemical cells 35. As shown in FIG. 1, the electrochemical cells 35 may include horizontally arranged cylindrical cells. It is to be appreciated, however, that any type of electrochemical cell may be employed.

In some embodiments, the casing 30 may be formed in any conventional fashion and of any conventional materials that allow for an interior volume of the module 25 to contain hold/maintain a thermal management fluid. In some embodiments, the casing 30 may entirely encase the electrochemical cells 35 such that the casing 30 forms a continuous casing surrounding the entirety of the electrochemical cells. Alternatively, the casing 30 may encase only a portion of the electrochemical cells 35 (e.g., one or more sides of the casing 30 may be at least partially open. In some embodiments, the interior volume of the modules 25 may be in fluid communication with the interior volume 20 of the housing 15. For example, one or more openings in an upper end of the casing 30 may permit fluid to be transferred from the interior volume of the modules 25 to the interior volume 20 of the housing 15 (i.e., the interior volume 20 may service as an overflow for fluid that is contained within the modules 25). Alternatively, or additionally, the casing 30 may include one or more inlets/outlets for permitting flow of fluid between the interior volume of the modules 25 and the interior volume 20 of the housing 15.

In some embodiments, a thermal management fluid F may be disposed within the interior volume 20 of the housing, the interior volume of the modules 25, or both. For example, in some embodiments, a thermal management fluid F may be disposed within the interior volume of one or more of the modules 25 such that substantially the entire volume (e.g., at least 80%, at least 90%, at least 95%, or at least 99%) of the interior volume of the modules 25 that is not occupied by electrochemical cells 35 (or any other solid components within the module 25) is occupied by the thermal management fluid F.

For purposes of illustration, in FIG. 1, the thermal management fluid F is disposed within the interior space 20 of the housing 15 such that a fluid level F_{L}′ is far below an upper end 15′ of the housing 15 and a minority of the surface area of the modules 25 is contacting the thermal management fluid F.

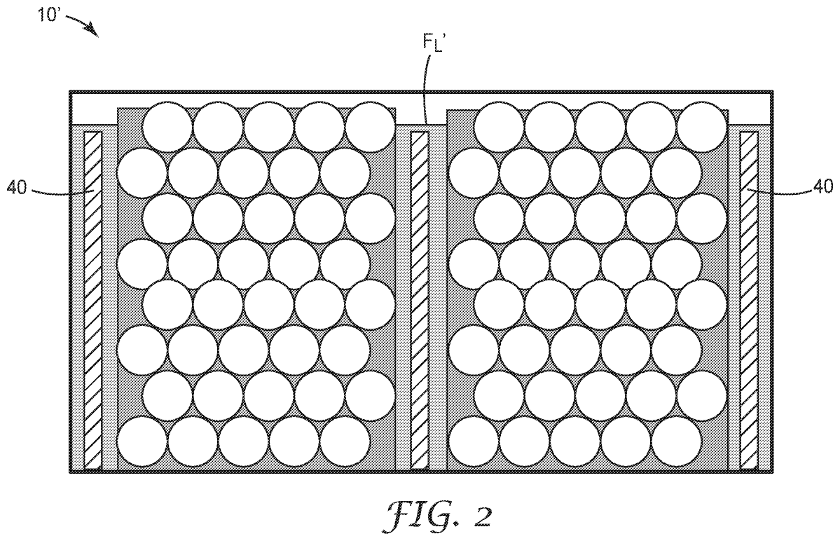

Referring now to FIG. 2, a battery pack 10′ having the same features as the battery pack 10 (including the same volume of thermal management fluid F disposed with the interior volume 20 of the housing and the interior volume of the modules 25), but that also includes one or more space fillers 40 according to the present disclosure, is shown. Generally, the space fillers 40 may be disposed anywhere within the interior volume 20 of the housing that is not occupied by the modules 25 (or any other solid components within the interior volume). As shown in FIG. 2, three space fillers 40 are employed—one between each of the modules and a side wall of the housing 15 and one between the modules 25. However, it is to be appreciated that the number, size, shape, and location of the space fillers 40 depicted in FIG. 2 is by way of example only. That is, any number, size, shape, and location of the space fillers 40 may be employed without deviating from the scope of the present disclosure.

Referring still to FIG. 2, as a result of the volume occupied by the space fillers 40, a fluid level F_{L}″ of the thermal management fluid within the interior volume 20 of the pack 10 (which, again, is the same volume of thermal management fluid that is contained in FIG. 1) is higher than fluid level F_{L}′ and, consequently, a higher fraction of the surface area of the modules 25 is immersed in the thermal management fluid F. In some embodiments, the thermal management fluid F may be disposed within the interior volume 20 such that substantially the entire volume (e.g., at least 80%, at least 90%, at least 95%, or at least 99%) of the interior volume 20 of the pack 10 that is not occupied by modules 25, the space fillers 40, or any other solid components within the interior volume 20 is occupied by the thermal management fluid F.

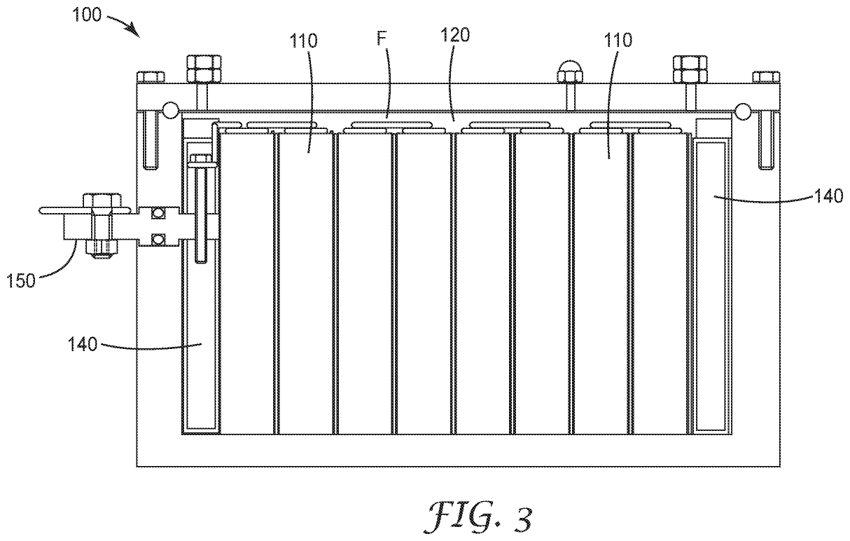

As previously discussed, the concepts of the present disclosure can be employed with respect to electrochemical cell packs having electrochemical cells of any type. In this regard, FIG. 3 illustrates an electrochemical cell pack 100 according to some embodiments of the present disclosure, in which a plurality of prismatic electrochemical cells 110 are contained. Similar to the embodiments of FIGS. 1-2, the electrochemical cell pack 100 includes a housing 115 that defines an interior volume 120 in which the plurality of prismatic cells 110 and a plurality of space fillers 140 are contained. As with the embodiment of FIGS. 1-2, a thermal management fluid F may also be disposed within the interior volume 120 of the housing 115.

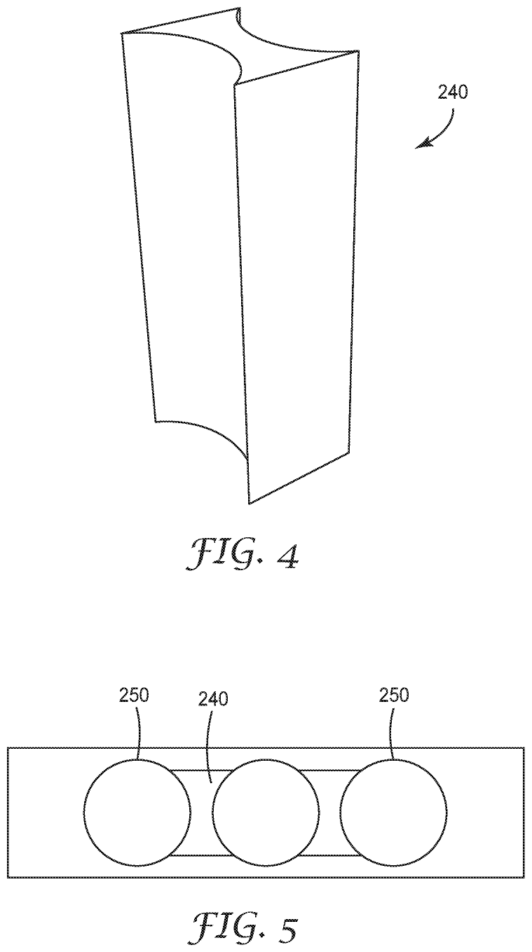

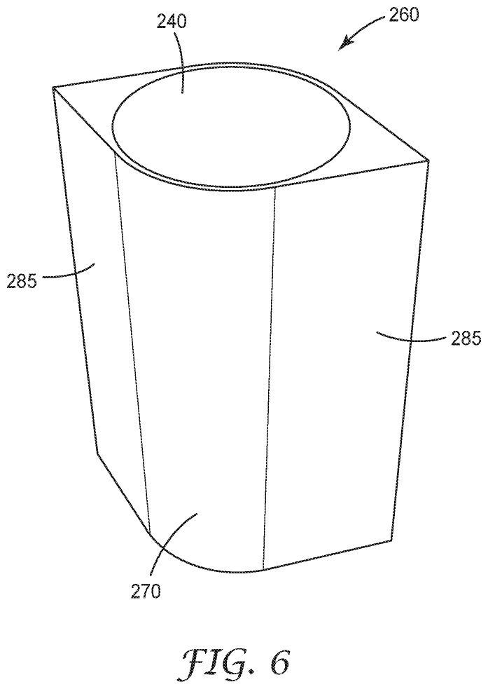

In some embodiments, as best described with respect to FIG. 3, one or more of the space fillers 140 may be sized and shaped to complement the size and shape of one or more structures or features disposed within the interior volume 120 (e.g., sized and shaped such that the space filler 140 (or multiple space fillers 140 in combination) fits snugly around the feature with minimal air gap). For example, as shown in FIG. 3, a space filler 140 may be sized and shaped to complement the size and shape of an electrical passthrough 150 that extends into the interior volume 120. In a similar fashion, space fillers 140 may be sized and shaped to complement the size and shape of any other structures or features disposed within the interior volume 120. For example, referring now to FIGS. 4A and 4B and FIG. 5, space fillers 240 in accordance with some embodiments of the present disclosure are illustrated. As shown, the space fillers 240 may be sized and shaped to complement the size and shape of adjacent cylindrical electrochemical cells 250, which may be disposed within a battery pack or battery pack module as described above. It is to be appreciated that in a similar fashion the space fillers 240 may be sized and shaped to complement the size and shape of any number of adjacent electrochemical cells (e.g., a 2×2 array of adjacent electrochemical cells). As another example, with reference to FIG. 6, the space fillers may be sized and shaped as a sleeve-like member having a cavity that is sized and shaped to complement the size and shape of an individual electrochemical cell. As shown in FIG. 6, a space filler 260 may include an elongated body 270 having a hollow portion 280 that defines a cavity that is sized and shaped to complement the size and shape of a cylindrical cell (not shown).

In any of the above-described embodiments, and as shown in FIG. 6, the space fillers of the present may also include one or more members (e.g., fins, protrusions, contoured surfaces), such as the members 285, extending transverse to the longitudinal dimension of the body of the space filler. Generally, these members may be configured to increase the surface area or volume of the space filler or optimize the flow of thermal management fluid around the electrochemical cells for purposes of heat transfer.

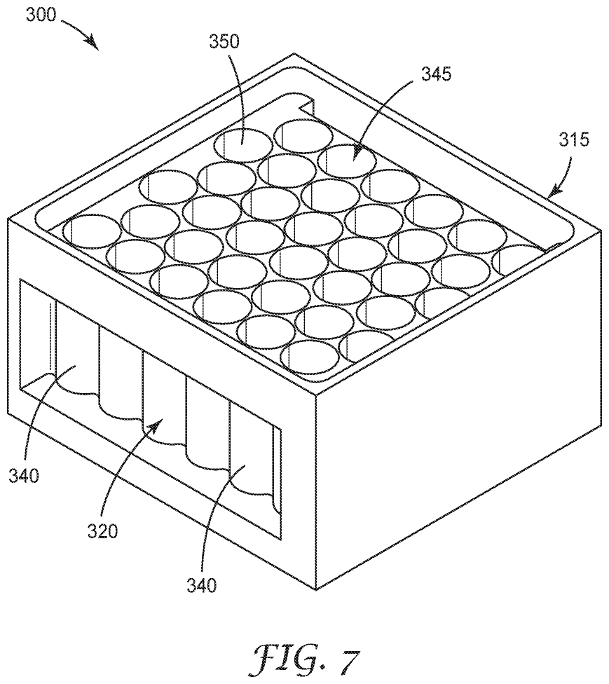

Referring now to FIG. 7, an electrochemical cell pack 300 (shown without electrochemical cells and thermal management fluid) according to some embodiments of the present disclosure is depicted. The electrochemical cell pack 300 may include a housing 315 having a plurality of sidewalls that define an interior volume 320. While FIG. 7 is depicted as having an open top side and a window that extends into the interior volume 320 from one of the side walls, it is to be appreciated that such features are primarily for illustration purposes (i.e., the housing 300 may have a top cover and not include a window in any sidewall) and that the housing 315 may have any shape or configuration that allows for the interior volume 320 to be fluidically sealed. The housing 300 may be formed in any conventional fashion and of any conventional materials.

In some embodiments, although not shown, the electrochemical cells with the pack 300 may be electrically connected to each other using any electrical conductor, such as busbars, wires, cables, or the like. The cells may be electrically coupled in a series configuration, a parallel configuration, or some combination of parallel and series configurations, as desired for the particular application.

In some embodiments, the pack 300 may further include a plurality of space fillers 340 configured as hollow, elongated members having an open top and bottom end, the hollow portions defining cavities 345 that are sized and shaped to accommodate the size and shape of the electrochemical cells and extend the length of the space filler 340. For example, as shown, the space fillers 340 may be formed as having elongated cylindrical cavities, each of the cylindrical cavities sized and shaped to accommodate the size and shape of cylindrical electrochemical cells. Similar to the embodiments of FIGS. 4-5, in some embodiments, the exterior surface of the space fillers 340 may be sized and shaped to complement the size and shape of adjacent space fillers such that the space or gap between adjacent space fillers 340 (in any direction) is minimized or substantially eliminated. In such embodiments, as will be further discussed below, thermal management fluid will be circulated (entirely or primarily) within the interior volume 320 via the cavities 345 as opposed to channels that could exist between adjacent space fillers 340. In this regard, in some embodiments, the space fillers 340 may be present within the interior volume 320 such that at least 50%, at least 75%, at least 80%, or at least 90% of the total interior volume that is not occupied by electrochemical cells is occupied by the space fillers 340.

While generally conforming to the size and shape of the electrochemical cells (the cells fit within the cavity with minimal gap), in some embodiments, the cavities 345 may be sized and shaped relative to the electrochemical cells such that the thermal management fluid may be passed between a sidewall 350 of the cavity and an outer surface of the electrochemical cells. In such embodiments, if centered within the cavity 345, an outer surface of the electrochemical cell (around the entire perimeter of the cell) may be spaced from the sidewall 350 a distance of between 0.01 mm and 10 mm, between 0.01 mm and 4 mm, between 0.1 mm and 1 mm, or between 0.25 mm and 0.5 mm, along the length of the cavity 345.

As with previous embodiments, a thermal management fluid (not depicted) may be disposed within the interior volume 320 of the housing 315. For example, in some embodiments, a thermal management fluid may be disposed within the interior volume 320 such that substantially the entire volume (e.g., at least 80%, at least 90%, at least 95%, or at least 99%) of the interior volume 320 that is not occupied by electrochemical cells or the space fillers 340 (or any other solid components within the interior volume 320) is occupied by the thermal management fluid. As with previous embodiments, given the presence of the space fillers, direct contact of the thermal management fluid with the surface of the electrochemical cells may be achieved while also minimizing the total volume of thermal management fluid with the pack 300.

As with previous embodiments, the number, size, shape, and location of the space fillers 340 depicted in FIG. 7 is by way of example only. That is, any number, size, shape, and location of the space fillers 340 may be employed without deviating from the scope of the present disclosure. In some embodiments, the space fillers 340 may be provided as discrete components. Alternatively, or additionally, one or more (up to all) of the space fillers 340 may be provided as a single body (such as by being integrally formed or by coupling two or more space fillers via a suitable fastening mechanism).

In some embodiments, the space fillers of the present disclosure may include a filler material and, optionally, a membrane the at least partially (and up to completely) encases the filler material.

In some embodiments, filler materials may include any material having a density (mass per unit volume) that is less than the density of the thermal management fluid F and/or is available at a lower cost than that thermal management fluid. In some embodiments, the filler materials may have a density that is greater than the density of the thermal management fluid. Examples of suitable filler materials include compressible gases (e.g, air), polymeric materials (such as nylon, polycarbonate, polyethylene, polyurethane, polystyrene, or combinations thereof), phase change materials such as paraffin wax for absorbing heat at constant temperature, or combinations thereof. Any of the polymeric materials may be present as polymeric open or closed cell foams. The filler materials may be selected such that they are nonflammable or of low flammability and may carry a UL-94 certification of HB, 5VB, 5VA, V-2, V-1 or V-0. The filler materials may be selected such that they have high electrical resistivity (e.g., greater than 1×10⁴ Ohm-cm). In some embodiments, the filler materials may exhibit compressibility as to allow for cell expansion and provide cushioning, with a Young's Modulus of no more than 3000 MPa (e.g. high density polymers), no more than 50 MPa (e.g. rubber), no more than 15 MPa (e.g. high density foam) or no more than 1 MPa (e.g. low density foam). In some embodiments, compressible gases may be present in the filler material in an amount of at least 50 volume %, at least 90 volume %, at least 95 volume %, or at least 99 vol. %, based on the total volume of the filler material. In some embodiments, polymers may be present in the filler material in an amount of at least 50 wt. %, at least 90 wt. %, at least 95 wt. %, or at least 99 wt. %, based on the total weight of the filler material.

In some embodiments, thermal conductivity of the filler materials may be enhanced by inclusion of one or more thermally conductive filler materials. For example, in embodiments in which the filler material includes a polymeric material, such polymeric material may have dispersed throughout its body one or more thermally conductive inorganic filler materials such as ceramics such as oxides, hydroxides, oxyhydroxides, silicates, borides, carbides, or nitrides.

In some embodiments, the membranes for the space fillers may include any materials that are compatible with the thermal management fluid (e.g., do not degrade in the presence of the fluid and do not cause degradation of the thermal management fluid) and are impermeable relative to the thermal management fluid, air, or both. Examples of suitable materials for the membrane may include polymers or metalized polymers. Particular examples include aluminized polymers, polypropylene foils, PET foils, or PTFE foils. In embodiments in which no membrane is employed, the filler material may include materials that are compatible with the thermal management fluid (e.g., do not degrade in the presence of the fluid, e.g. dissolution of containing plasticizer, and do not cause degradation of the thermal management fluid).

In some embodiments, two or more pieces of the membrane may be coupled or joined to at least partially encase the filler material (e.g., form a pouch that at least partially encases the filler material). For example, top and bottoms sections of a membrane may be brought together and sealed about one or more edges to form a pouch or pocket for encasing the filler material. In some embodiments, the membrane (or one or more pieces of membrane that, collectively (or when joined), make up the total membrane) may be formed of a single layer of material or a plurality of material layers (e.g., multi-layer film).

In some embodiments, the space fillers of the present disclosure may be characterized as sealed, compressible gas filled pouches. In such embodiments, the space filler may include or consist essentially of a compressible gas and the membrane may fully encase the space filler such that the compressible gas is retained within a pouch formed by the membrane (e.g., via a seal disposed about the perimeter of the membrane). In such embodiments, the compressible gas may occupy at least 95%, at least 99%, or 100% of the total volume of the pouch.

In some embodiments, the volume occupied by the space fillers within the interior volume of electrochemical cell pack housing, cumulatively, may be at least 10%, at least 20%, at least 30%, at least 40%, at least 50%, at least 60%, at least 70%, at least 80%, at least 90%, at least 100%, at least 110%, at least 150%, at least 200%, or at least 300% of the volume occupied by the thermal management fluid within the interior volume of electrochemical cell pack housing. In some embodiments, the thermal management fluid may be present in the interior volume of electrochemical cell pack housing such that there is between 0.02 and 2 liters/kW-h, 0.02 and 1 liters/kW-h, or between 0.02 and 0.5 liters/kW-h, based on the total (cumulative) energy of the electrochemical cells present in the electrochemical cell pack.

As previously discussed, the space fillers of the present disclosure may have a density that is less than the density of the thermal management fluid in which they are disposed. Therefore, in some embodiments, to prevent movement of the space fillers within the pack (e.g., via buoyancy forces), the space fillers may be held in position using any suitable coupling mechanism. Suitable coupling mechanisms may include adhesives, fasteners, or structural elements within the interior volume that serve to maintain the position of the space fillers within the interior volume.

### Fluids

In some embodiments, the thermal management fluids may include or consist essentially of halogenated compounds, oils (e.g., mineral oils, synthetic oils, or silicone oils), or combinations thereof. In some embodiments, the halogenated compounds may include fluorinated compounds, chlorinated compounds, brominated compounds, or combinations thereof. In some embodiments, the halogenated compounds may include or consist essentially of fluorinated compounds. In some embodiments, the thermal management fluids may have an electrical conductivity (at 25 degrees Celsius) of less than about 1e-5 S/cm, less than about 1e-6 S/cm, less than 1e-7 S/cm, or less than about 1e-10 S/cm. In some embodiments, the thermal management fluids may have a dielectric constant that is less than about 25, less than about 15, or less than about 10, as measured in accordance with ASTM D150 at room temperature. In some embodiments, the thermal management fluids may have any one of, any combination of, or all of the following additional properties: sufficiently low melting point (e.g., <−40 degrees C. or −35 degrees C.) and high boiling point (e.g., >80 degrees C. for single phase heat transfer), high thermal conductivity (e.g., >0.05 W/m-K), high specific heat capacity (e.g., >800 J/kg-K), low viscosity (e.g., <2 cSt at room temperature), and non-flammability (e.g., no closed cup flashpoint) or low flammability (e.g., flash point >100 F). In some embodiments, fluorinated compounds having such properties may include or consist of any one or combination of fluoroethers, fluorocarbons, fluoroketones, fluorosulfones, and fluoroolefins. In some embodiments fluorinated compounds having such properties may include or consist of partially fluorinated compounds, perfluorinated compounds, or a combination thereof. In some embodiments, the thermal management fluid may include fluorinated compounds in an amount of at least 20%, at least 50 wt. %, at least 75 wt. %, at least 90 wt. %, at least 95 wt. %, or at least 99 wt. %, based on the total weight of the thermal management fluid.

In some embodiments, the thermal management fluids of the present disclosure may be relatively chemically unreactive, thermally stable, and non-toxic. The working fluids may have a low environmental impact. In this regard, the working fluids of the present disclosure may have a zero, or near zero, ozone depletion potential (ODP) and a global warming potential (GWP, 100 yr ITH) of less than 500, 300, 200, 100 or less than 10.

In some embodiments, the electrochemical cell packs of the present disclosure may be may be configured to store and supply electrical power to any electrical system, such as in a Battery Electric Vehicle (BEV), a Plug-in Hybrid Electric Vehicle (PHEV), a hybrid electric vehicle (HEV), an Uninterruptible Power Supply (UPS) system, a residential electrical system, an industrial electrical system, a stationary energy storage system, or the like.

In some embodiments, during operation or use of the electrochemical cell packs, the thermal management fluid may be circulated (e.g., via a pump) within or to/from the interior volume of the housing. For example, the thermal management fluid may be provided to the housing though pipes or hoses and may flow around or between the modules or electrochemical cells before periodically or continuously being routed to a radiator or heat exchanger. In some embodiments, after flow through the radiator or heat exchanger, the thermal management fluid may be once again routed to the electrochemical cells. Alternatively, the thermal management fluid may not be circulated within or to/from the housing.

### Examples

Objects and advantages of this disclosure are further illustrated by the following comparative and illustrative examples. Unless otherwise noted, all parts, percentages, ratios, etc. in the examples and the rest of the specification are by weight, and all components used in the examples were obtained, or are available, from general suppliers such as, for example, Sigma-Aldrich Corp., Saint Louis, Mo., US or Thermo-Fisher Scientific, Waltham, Mass., US. The following abbreviations are used herein: Amps=amperes; Ahr=ampere-hours; in =inches; mm=millimeters; cm=centimeters; ml=milliliters, L=liters, sec=seconds min=minutes, hr=hours, V=volts, ° C.=degrees Celsius, g=grams.

### Electrochemical Cell Configuration

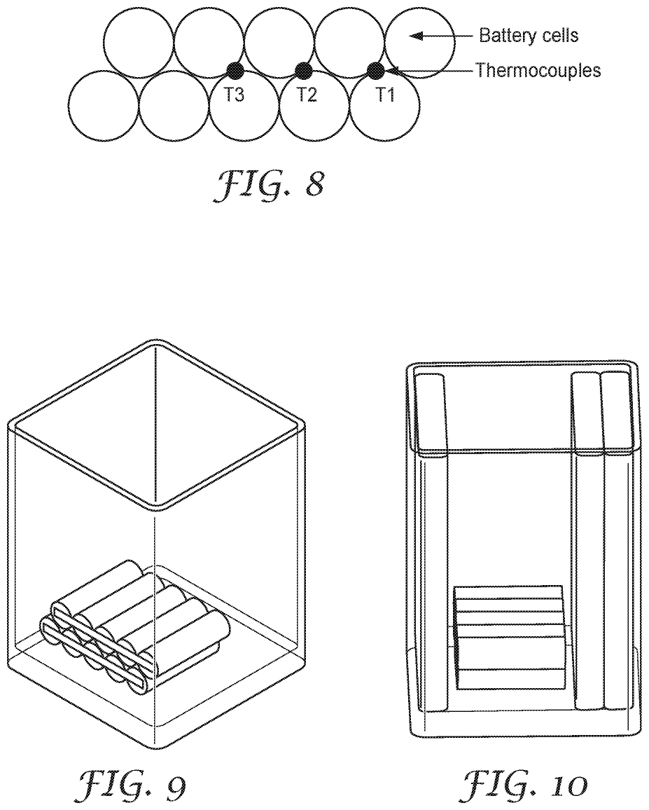

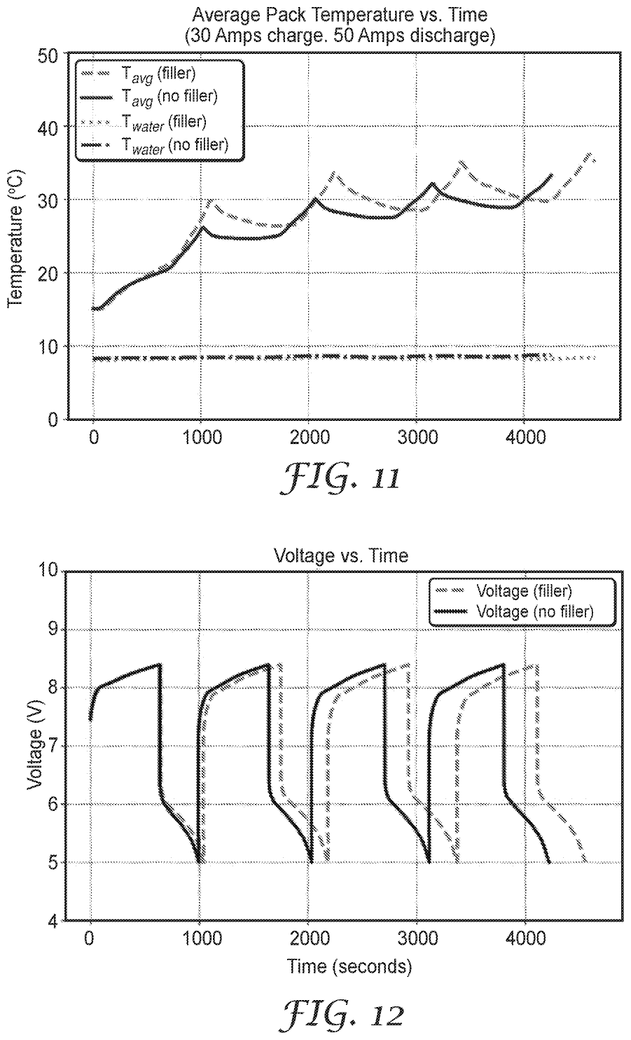

Ten cylindrical format electrochemical cells, each having a diameter of 21 mm and a length of 70 mm, were assembled into a 2S5P battery pack configuration as shown in FIG. 7 by welding them together with nickel strips, using an industrial-grade spot welder. Table 1 provides details of the battery cells and nickel strips. Three type K thermocouples were attached to the cells, near the midpoint of the height of the cells, at the positions shown in FIG. 8.

TABLE 1
Materials

| Item | Supplier | Part # |
|---|---|---|
| 21700 battery cells (4 Ahr) | Samsung SDI, Yongin, South | INR21700- |
| | Korea | 40T |
| Nickel strips, 0.005 in | Sunstone Welders, Payson, | SN250N54 |
| (0.127 mm) thickness | UT, US | |

### Comparative Example: No Space Filler

The battery pack was placed into a glass vessel of square cross-section with internal dimensions 14 cm×14 cm×18.5 cm. For the comparative, 1000 ml of NOVEC 7300 fluid (1,1,1,2,2,3,4,5,5,5-decafluoro-3-methoxy-4-(trifluoromethyl)-pentane, available from 3M Company, Saint Paul, Minn., US) was placed in the vessel with the battery pack. No space fillers were added to the vessel. The height of the fluid from the bottom of the vessel on the outside was measured to be 8 cm. A schematic of the test vessel is shown in FIG. 9.

To dissipate heat transferred to the working fluid during testing, cold water was flowed through a cooling tube, made from a 40 cm length of ⅛ inch (0.32 cm) outer diameter copper tube, and bent so that a 24 cm long U-shaped section was immersed in the fluid above the battery pack. The water flow rate was determined by recording the time required to collect 1000 ml of water in a graduated cylinder using a calibrated stop watch (Thermo-Fisher Scientific, Waltham, Mass., US). An average of two flow rate measurements were taken, as shown in Table 2.

TABLE 2
Water Flow Rate Measurements

| | Measurement #1 | Measurement #2 | Average |
|---|---|---|---|
| Volume (L) | 1.0 | 1.0 | — |
| Time (sec) | 27.58 | 28.03 | — |
| Flow rate (L/min) | 2.18 | 2.14 | 2.16 |

The battery pack was then cycled (charged and discharged) 4 times from 5 Volts to 8.4 Volts at a constant current charge of 30 Amps and constant current discharge of 50 Amps. Voltage and temperature were logged during the cycling procedure.

### Example 1: Foam/Metallized Film Space Filler

Materials used to prepare the space fillers for Example 1 are provided in Table 3. Three exemplary space fillers were made by inserting 3 sheets of 14 cm×18 cm×0.635 cm polyurethane foam sheet into 7.5 mil thick metallized bags, cutting the bags to size, and heat sealing the bags.

TABLE 3
Materials used for Space Filler Example 1

| Item | Supplier | Part # |
|---|---|---|
| Polyurethane foam sheet, ¼ | McMaster-Carr, Elmhurst, | 86375K234 |
| inch (0.64 cm) thick | IL, US | |
| PAKDRY 7500 metallized | IMPAK/Sorbent Systems, | P75C1020 |
| bags | Los Angeles, CA, US | |

The battery pack and the three space fillers were placed into the same glass vessel used for Comparative Example CE1. NOVEC 7300 fluid was then added to the glass vessel to a height of 8 cm and the volume of fluid was recorded as 500 ml. A schematic of the test vessel setup is shown in FIG. 10.

To dissipate heat transferred to the working fluid during testing, cold water was flowed through a cooling tube, made from a 40 cm length of ⅛ inch (0.32 cm) outer diameter copper tube, and bent so that a 24 cm long U-shaped section was immersed in the fluid above the battery pack. The water flow rate was the same as for the Comparative Example. The battery pack was cycled (charged and discharged) using the same test protocol as the Comparative Example.

### Results

Average pack temperatures (average from the three thermocouples T1, T2, T3) and voltages for Example 1 and the Comparative Example are shown in FIG. 10, and the maximum and average pack temperatures for the entire test protocol are summarized in Tables 4 and 5, respectively. Results show that the maximum and average temperatures of the battery pack for the Comparative Example and for Example 1 vary by only 2 to 3° C., even though the fluid volume used in Example 1 was reduced by 50% by using space fillers of the present disclosure.

TABLE 4
Maximum Temperature

| Thermocouple | Comparative Example | Example 1 |
|---|---|---|
| T1 | 33.5° C. | 35.7° C. |
| T2 | 33.1° C. | 36.0° C. |
| T3 | 33.2° C. | 36.7° C. |

TABLE 5
Average Temperature

| Thermocouple | Comparative Example | Example 1 |
|---|---|---|
| T1 | 26.2° C. | 27.5° C. |
| T2 | 26.0° C. | 27.6° C. |
| T3 | 26.2° C. | 28.4° C. |

The weight of the fluid used in Comparative Example and the fluid and space filler (foam only) used in Example 1 were calculated using the densities provided in Table 6 and the measured volumes of NOVEC 7300 fluid. The volume of the foam was taken as the volume of fluid it displaced. Final weight comparisons are shown in Table 7, showing a reduction in fluid weight of approximately 42% for the pack with space filler versus the pack without.

TABLE 5
Density Values

| | NOVEC 7300 | Foam Space Filler |
|---|---|---|
| Density, g/cm³ | 1.66 | 0.24 |

TABLE 6
Calculated Weight of Fluid vs. Fluid + Foam Space Filler

| | Comparative Example | Example 1 (with |
|---|---|---|
| | (no space filler) | space fillers) |
| Volume of NOVEC 7300, ml | 1000 | 500 |
| Volume of foam, ml | 0 | 500 |
| Weight, g | 1660 | 950 |

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows. All references cited in this disclosure are herein incorporated by reference in their entirety.

1. An electrochemical cell pack comprising:
a housing having an interior volume;
a plurality of electrochemical cells disposed within the interior volume;
a thermal management fluid disposed within the interior volume such that the plurality of electrochemical cells is in thermal communication with the thermal management fluid; and
one or more space fillers disposed with the interior volume and in direct contact with the thermal management fluid, wherein the space fillers have a density that is less than the density of the thermal management fluid.

2. The electrochemical cell pack of claim 1, wherein a volume occupied by the space fillers within the electrochemical cell pack, cumulatively, is at least 20% of the volume occupied by the thermal management fluid within the electrochemical cell pack.

3. An electrochemical cell pack comprising:
a housing having an interior space;
a plurality of electrochemical cells disposed within the interior space;
a thermal management fluid disposed within the interior space such that the plurality of electrochemical cells is in thermal communication with the thermal management fluid; and
one or more space fillers disposed with the interior volume and in direct contact with the thermal management fluid;
wherein the volume occupied by the space fillers within the interior space, cumulatively, is at least 20% of the volume occupied by the thermal management fluid within the interior space.

4. The electrochemical cell pack of claim 1, wherein the thermal management fluid comprises a halogenated fluid or an oil.

5. The electrochemical cell pack of claim 1, wherein the thermal management fluid has an electrical conductivity (at 25 degrees Celsius) of less than 1e-5 S/cm.

6. The electrochemical cell pack of claim 1, wherein the thermal management fluid comprises a fluoroether, fluorocarbon, fluoroketone, fluorosulfone, or fluoroolefins.

7. The electrochemical cell pack of claim 1, wherein the thermal management fluid comprises fluorinated compounds in an amount of at least 20 wt. %, based on the total weight of the thermal management fluid.

8. The electrochemical cell pack of claim 1, wherein the space filler comprises a filler material comprising a polymeric material and wherein the polymeric material is present in the space filler in an amount of at least 50 wt. percent, based on the total weight of the space filler.

9. The electrochemical cell pack of claim 1, wherein the space filler comprises a filler material comprising a compressible gas and wherein the compressible gas is present in an amount of at least 95 volume percent, based on the total volume of the space filler.

10. The electrochemical cell pack of claim 1, wherein the space filler comprises a filler material comprising thermally conductive inorganic filler particles.

11. The electrochemical cell pack of claim 1, wherein the space filler comprises a membrane that at least partially encases a filler material.

12. The electrochemical cell pack of claim 11, wherein the membrane is compatible with the thermal management fluid and is impermeable relative to the thermal management fluid or air.

13. The electrochemical cell pack of claim 11, wherein the membrane comprises a polymer or a metalized polymer.

14. The electrochemical cell pack of claim 1, further comprising one or more modules, each of the one or more modules comprising a casing that at least partially encases a plurality of the electrochemical cells.

15. The electrochemical cell pack of claim 14, wherein the thermal management fluid is further disposed within an interior space of the one or more modules.

16. An electrical power system comprising:
the electrochemical cell pack of claim 1,
a heat exchanger in fluid communication with the thermal management fluid;
a fluid pump in fluid communication with the thermal management fluid and the heat exchanger; and
an electrical load, wherein the electrochemical cell pack is electrically coupled to the electrical load.

17. The electrical power system of claim 16, wherein the electrical load is a motor for propelling an electric vehicle.
